(19) United States
(12) Patent Application Publication
(10) Pub. No.: US 2002/0073123 A1
(43) Pub. Date: Jun. 13, 2002

(54) Method for displaying overlapping documents in a computer environment

(76) Inventor: Wen-Sung Tsai, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/731,838

(22) Filed: Dec. 8, 2000

(51) Int. Cl. G06F 17/24

(52) U.S. Cl. 707/526; 707/515

(57) ABSTRACT

A computer system with a memory for storing programs and data, a processor for executing programs stored in the memory, a video display for displaying video images generated by the programs, an input device connected to the processor, and first and second documents simultaneously displayed by at least a first program over the video display in an overlapping manner. The input device enables a user to provide input data to a program executed by the processor. When a user is processing the first document by using the first program and the input device, the overlapping portion of the first document displayed on the video display is completely visible to the user and the overlapping portion of the second document displayed on the video display is partially visible to the user so that the user can partially see the second document while working on the first document.

### BACKGROUND OF THE INVENTION

1. Field of the Invention

The present invention relates to a display method for a computer system. More specifically, the present invention discloses a method for simultaneously viewing two overlapping documents in a computer system with a windowing environment.

2. Description of the Prior Art

Most operating systems for personal computers currently employ a windowing system that permits the viewing and running of several documents at once. These documents may be for separate program applications, or for separate tasks within a single application. Generally, such documents are termed windows, and can be moved and resized. Please refer to FIG. 1. FIG. 1 is a block diagram of a prior art computer system 10. The computer system 10 comprises a display 20, a processor 30, a memory 40 and an input device 50. The input device 50 comprises a mouse 52 and a keyboard 54. The processor 30 controls the contents of the display 20, and receives input from a user (not shown) by way of the mouse 52 or keyboard 54. The memory holds an operating system program 42, which the processor 30 executes. The operating system 42 is a windowing platform under which a first application program 44 and a second application program 46 run. To enable visual output onto the display 20, the operating system 42 provides the first application 44 with a first document window 24, and the second application 46 with a second document window 26. The first application 44 and the second application 46 do not output directly to the display 20. Instead, they each send commands to the operating system 42 to draw into their respective windows 24 and 26. The operating system 42 interprets these commands to build the total contents of the display 20.

The first document 24 and second document 26 are implemented by the operating system 42 to behave much like individual sheets of paper, and hence, by using the input device 50, they can be made to move over the displayable surface of the display 20. The first and second documents 24 and 26 can also be made to slide over each other. Generally, the foreground application will appear as topmost in the display 20. A foreground application is that which actively receives input from the keyboard 54. Hence, the first document 24 is in the foreground of the display 20, indicating that the first application 44 is currently the active application receiving input from the keyboard 54.

There are times when a user may desire to view the entirety of both the first document 24 and the second document 26. Often this poses no problem, as the relative positions of the documents 24 and 26 can be moved on the display 20 so that the documents 24 and 26 do not overlap each other. Occasionally, though, this is not possible, as one or both of the documents 24 and 26 may be too large to prevent overlapping with the other document. In this case, as shown in FIG. 1, the second document 26 will have a portion that is unreadable as it is covered by the first document 24. This can be a source of annoyance for the user, as he or she will then have to continually bring one of the documents 24 and 26 forward into the foreground for full viewing, and then send it back to the background to fully view the other document.

### SUMMARY OF THE INVENTION

It is therefore a primary objective of this invention to provide a window viewing system that enables a user to simultaneously view an overlapped region in one document through the corresponding overlapping region of another document.

The present invention, briefly summarized, discloses a computer system with a memory for storing programs and data, a processor for executing programs stored in the memory, a video display for displaying video images generated by the programs, an input device connected to the processor, and first and second documents simultaneously displayed by at least a first program over the video display in an overlapping manner. The input device enables a user to provide input data to a program executed by the processor. When a user is processing the first document by using the first program and the input device, the overlapping portion of the first document displayed on the video display is completely visible to the user and the overlapping portion of the second document displayed on the video display is partially visible to the user so that the user can partially see the second document while working on the first document.

It is an advantage of the present invention that by enabling the overlapping region of the second document to be at least partially visible to the user through the first document, the user does not need to bring the second document into the foreground to view the overlapping region covered by the first document. This reduces the tedium of working with overlapping documents whose contents must be fully and simultaneously readable.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a block diagram of a prior art computer system.

FIG. 2 is a first block diagram of a present invention computer system.

FIG. 3 is a second block diagram of a present invention computer system.

FIG. 4 is a third block diagram of a present invention computer system.

FIG. 5 is a fourth block diagram of a present invention computer system.

### DETAILED DESCRIPTION OF THE PREFERRED EMBODIMENT

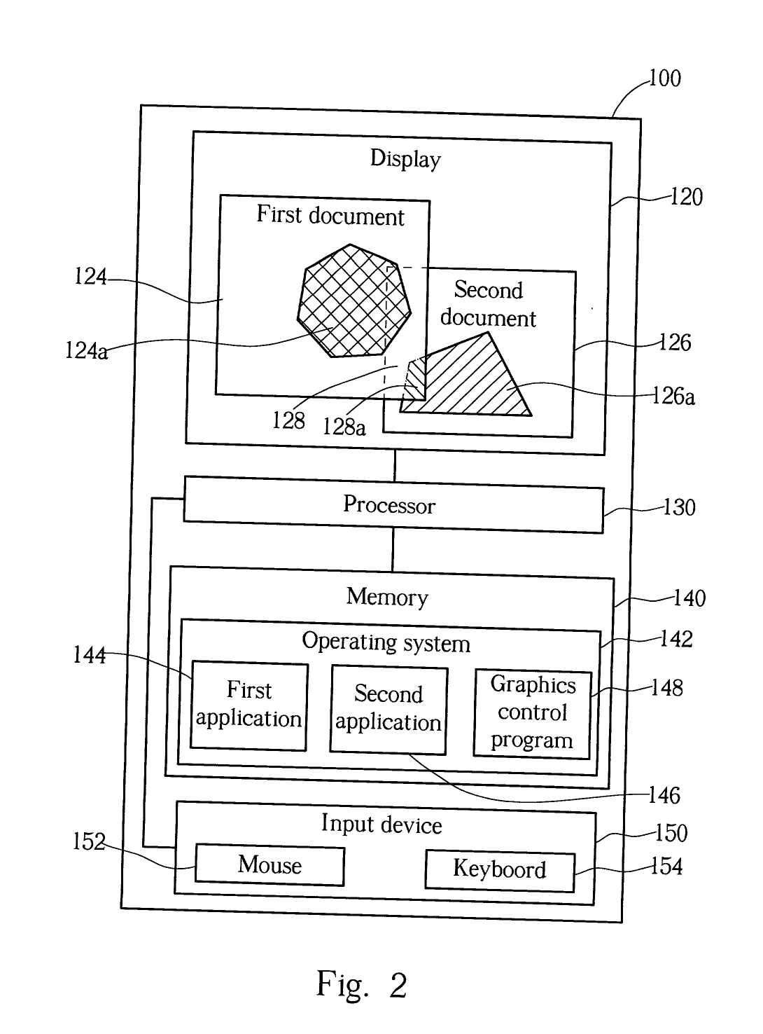

Please refer to FIG. 2. FIG. 2 is a block diagram of a computer system 100 according to the present invention. The computer system 100 comprises a display 120, a processor 130, a memory 140 and an input device 150. The input device 150 comprises a mouse 152 and a keyboard 154. The processor 130 controls the contents of the display 120, and receives input from a user (not shown) by way of the mouse 52 or keyboard 54. The memory 140 holds an operating system program 142, which the processor 130 executes. The operating system 142 is a windowing platform under which a first application program 144 and a second application program 146 is run, executed by the processor 130. To enable visual output onto the display 120, the operating system 142 provides the first application 144 with a first document window 124, and the second application 146 with a second document window 126. As noted in the prior art, the first application 144 and the second application 146 do not output directly to the display 120. Instead, they each send commands to the operating system 142 to draw into their respective windows 124 and 126. The operating system 142 interprets these commands to build the total contents of the display 120. The computer system 100 additionally has a graphics control program 148 running under the operating system 142. The graphics control program 148 assists the operating system 142 with the drawing of the first and second document windows 124 and 126 to implement the present invention.

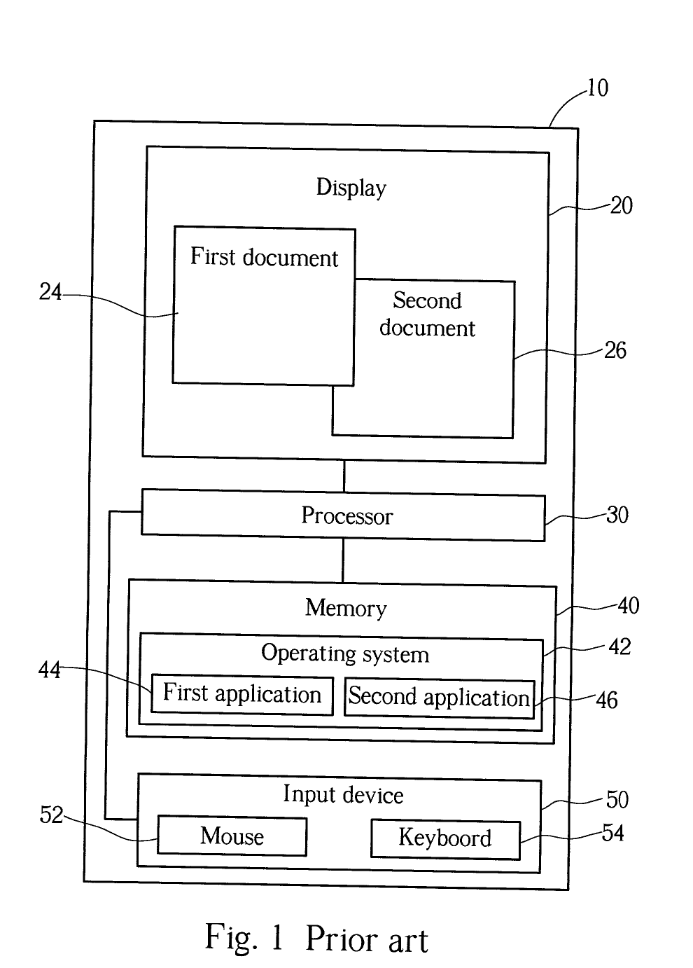

In the following explanation, simple geometric figures are used to more easily illustrate the salient features of the present invention. It should be understood, however, that the present invention is applicable to any sort of graphical commands which may be drawn into the document windows 124 and 126, including text. As shown in FIG. 1, the first document window 124 is in the foreground, receiving input from the keyboard 154, and possibly from the mouse 152. As such, an overlapping portion 128 of the first document window 124 is on top of the second document window 126. A geometric item 124a in the first window 124 is drawn normally in all regions of the first document window 124, according to drawing commands received from the first application program 144. Similarly, the geometric item 126a is drawn normally in the non-overlapped regions of the second document window 126 according to drawing commands received from the second application program 146. However, within the region of overlap 128, the graphics control program 148 causes a color-biased portion of the item 126a to be seen on the first document window 124 where it would normally be covered by the first document window 124. For example, if the graphics control program caused the overlapped regions 128 of the second document window 126 to be biased towards blue, and the item 126a is normally colored in red, an overlapped portion 128a may be drawn on the first document window 124 having a purple color.

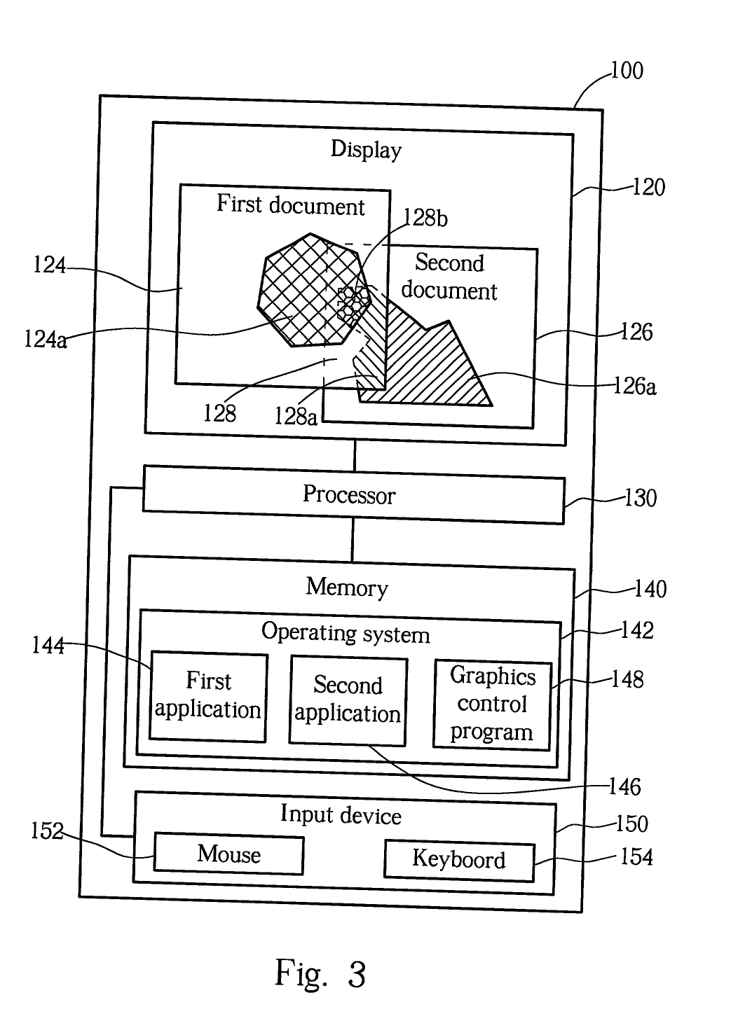

Please refer to FIG. 3. FIG. 3 is a second block diagram of the present invention computer system 100. As shown in FIG. 3, it is fully possible for the geometric items 124a and 126a to have regions of mutual overlap. Item numberings in the figures are kept the same for items having characteristics consistent across the figures. In region 128a, geometrical item 126a of the second document window 126 is overlapped by the first document window 128, but is not overlapped by the geometrical item 124a of the first document window 124. Hence, within region 128a, item 126a is drawn on window 124 in a color biased only towards the bias color, say blue, and thus, consistent with the above example, would be drawn in purple. In region 128b, however, item 126a is overlapped by item 124a. Within region 128b, item 126 would be drawn in a color that is biased towards both the bias color (i.e., blue) and the color of item 124a. If, for example, item 124a is filled with green, then within region 128b, item 126a would be drawn in a color biased towards cyan (blue and green). The relative weightings of the biasing colors used by the graphics control program 148 could be set by the user. That is, it should be clear that the final color used by the graphics control program 148 when drawing into the first document window 124 to reveal regions of item 126a covered by the first document window 124 is a function of the color of item 126, the biasing color and the color of item 124a. This function could be a weighted averaging function, and the user could set the different averaging weights to make the overlapped portions of item 126a more or less visible on the first document window 124, and to more or less clearly highlight those regions 128a that are overlapped by the first document window 124.

To offer a more detailed description of the above, consider the following definitions:

Color_{draw}: Color used by graphics control program 148 to make an overlapped point visible on the foreground document window.

Color_{oiginal}: Original color of the background document window at the overlapped point.

Color_{bias}: Biasing color for overlapped regions.

Color_{window}: Original color of the foreground document window at the overlapped point.

For the above, the graphics control program would use the following formula to draw into the first document window 124:

Color_{draw}=A*((1.0−B)*Color_{original}+B*Color_{bias})+(1.0−A)*Color_{window}

Where:

0<=A<=1.0

And:

0<=B<=1.0

By increasing the relative weighting of parameter A, item 126a becomes more visible in the first document window 124. By increasing the relative weighting of parameter B, a greater contrast in color is made between overlapping and non-overlapping regions of item 126a.

The above formula offers some specific cases that are of interest. For example, by setting the biasing color to black, parameters A and B would determine the effective transparency of the first document window 124 to the second document window 126. Alternatively, if the first and the second document windows 124 and 126 use a gray scale, by setting the biasing color to white, overlapped regions of the second document window 126a will appear as lighter ghost images on the first document window 124.

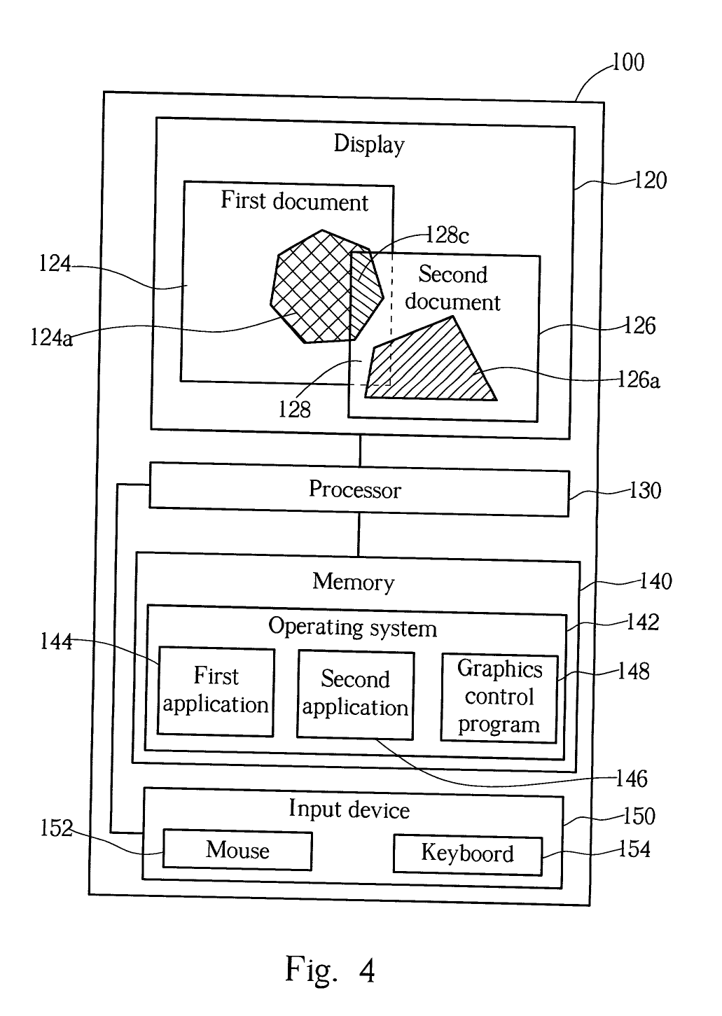

Please refer to FIG. 4. FIG. 4 is a third block diagram of the present invention computer system 100. The user may use the mouse 152 or the keyboard 154 to bring the second document window 126 to the foreground. When this occurs, the first document window 124 goes to the background and the overlapping region 128 of the second document window 126 is on top of the first document window 124. The graphics control program 148 thus makes the overlapped region 128c of item 124a visible on the second document window 126.

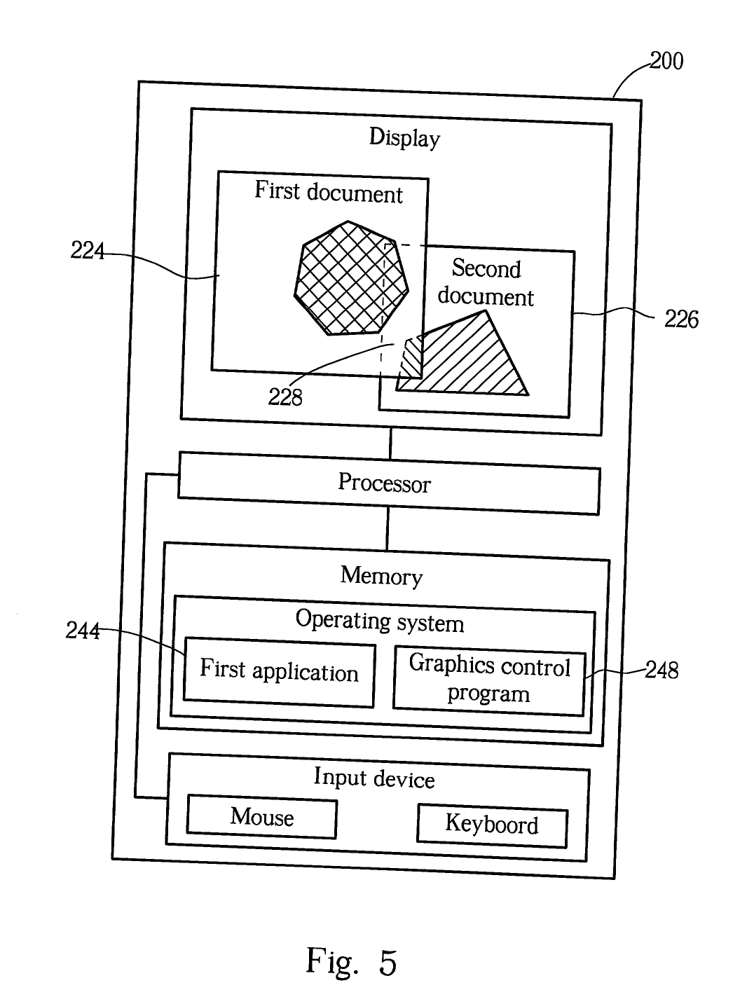

Finally, it should be noted that although the above description has been with reference to two application programs 144 and 146, each with a respective document window 124 and 126, it is equally possible for the present invention to work with a single application program that uses two document windows. Please refer to FIG. 5. FIG. 5 is a fourth block diagram of a present invention computer system 200. The computer system 200 is nearly identical to the computer system 100, except that a single application program 244 generates two document windows: a first document window 224 and a second document window 226. When the first document window 224 is in the foreground, the graphics control program 248 enables the overlapped region 228 of the second document window 226 to be visible on the first document window 224. Similarly, when the second document window 226 is in the foreground, the graphics control program 248 enables the overlapped region 228 of the first document window 224 to be visible on the second document window 226. The graphics control program 248 of the computer system 200 treats the document windows 224 and 226 in exactly the same way as the graphics control program 124 of the computer system 100 treated the document windows 124 and 126. As far as a generic graphics control program of the present invention is concerned, there is no difference between document windows created by a single application, or document windows created by separate applications. Both are treated in exactly the same manner.

In contrast to the prior art, the present invention provides a graphics control program that enables an overlapped portion of a second window to be at least partially visible on the corresponding overlapping region of a first window. The graphics control program uses a color modification algorithm that modifies the original colors of the overlapped region in the second window to present them in the overlapping region of the first window. In this manner, the first window can be made to appear transparent to the second window, and a user can thus simultaneously view the entire contents of both the first and second windows, thereby eliminating any need to switch back and forth between the two windows to view the windows.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A computer system comprising:
a memory for storing programs and data;
a processor for executing programs stored in the memory;
a video display for displaying video images generated by the programs;
an input device connected to the processor wherein a user can input data to a program executed by the processor through the input device; and
first and second documents simultaneously displayed by at least a first program over the video display in an overlapping manner;
wherein when a user is processing the first document by using the first program and the input device, the overlapping portion of the first document displayed on the video display is completely visible to the user and the overlapping portion of the second document displayed on the video display is partially visible to the user so that the user can partially see the second document while working on the first document.

2. The computer system of claim 1 wherein the first and second documents are processed and displayed by the first program at the same time.

3. The computer system of claim 2 wherein the user can switch the first and second documents by using the first program to make the overlapping portion of the second document completely visible and make the overlapping portion of the first document partially visible so that the user can work on the second document.

4. The computer system of claim 1 wherein the first document is processed and displayed by the first program while the second document is processed and displayed by a second program at the same time.

5. The computer system of claim 4 wherein the first and second programs are executed in a window-based platform and the user can switch the first and second documents by using the window-based platform to make the overlapping portion of the second document completely visible and make the overlapping portion of the first document partially visible so that the user can work on the second document.

6. The computer system of claim 1 wherein the first and second documents are displayed on the video display in different colors.

7. The computer system of claim 1 wherein the first and second documents are displayed on the video display in different gray levels, the first document having a darker gray level and the second document having a lighter gray level.

8. The computer system of claim 1 wherein the visibility of the second document to the user is defined by a transparency factor wherein the transparency factor can be controlled by the user by using the input device.

9. The computer system of claim 1 wherein the first program is an editing program or a spread sheet program.
